(19) United States
(12) Patent Application Publication
(10) Pub. No.: US 2026/0358155 A1
(43) Pub. Date: Nov. 12, 2026

(54) SENSOR ELEMENT AND MEASURING SYSTEM PRODUCED THEREWITH

(71) Applicant: Endress+Hauser Flowtec AG, Reinach (CH)

(72) Inventor: Anton Rieger, Weil am Rhein (DE)

(21) Appl. No.: 19/120,903

(22) PCT Filed: Sep. 7, 2023
(86) PCT No.: PCT/EP2023/074654

§ 371 Date: Apr. 14, 2025

(30) Foreign Application Priority Data
Oct. 18, 2022 (DE) 10 2022 127 160.9

(51) Int. Cl. G01F 1/32; G01F 1/325

(52) U.S. Cl. CPC G01F 1/3209; G01F 1/3266

(57) ABSTRACT

A sensor element includes: a base body with a base body cavity; a deformation body with a deformation cavity; a reference body made of an electrically conductive material; and a filling body made of an electrically non-conductive, insulating material, with a filling body cavity. The reference body is partly arranged within the deformation body cavity, thereby forming a gap between the deformation body and the reference body, which are arranged such that a deformation body inner surface and a reference body surface do not contact each other. The deformation body configured to enable a vibrating movement about a static rest position and thereby move relative to the reference body such that the deformation body executes a vibrating movement which changes the cavity thereof or the gap, therefore changing a capacitance that can be measured between the deformation body and the reference body.

The invention relates to a (capacitive) sensor element, in particular a sensor element for (capacitive) detection of pressure fluctuations in a Kármán vortex street, formed in a flowing fluid, and/or a sensor element designed to be contacted by a flowing fluid.

In process measurement and automation technology, measuring systems designed as vortex flow meters are often used for the measurement of flow velocities of fluid measurement media, or (measurement) fluids, flowing in pipes, in particular fast-flowing and/or hot gases (>100 °C) and/or fluid flows of high Reynolds number (Re>10,000), or of volume flow rates or mass flow rates corresponding to a respective flow velocity (u). Examples of such measuring systems are known, inter alia, from US-A 47 16 770, US-A 60 03 384, US-B 69 10 387, US-B 69 38 496, US-B 97 19 819, US-B 1 08 45 222, or US-B 1 09 48 321 and are also offered, inter alia, by the applicant—for example, under the trade name “PROWIRL D 200,” “PROWIRL F 200,” “PROWIRL O 200,” “PROWIRL R 200” (http://www.de.endress.com/en/search?filter.text=prowirl).

Each of the aforementioned measuring systems has a resistance element, which protrudes into the lumen of the respective pipe, viz., for example, designed as a system component of a heat supply network or of a turbine circuit, or into a lumen of a measurement tube used in the course of said pipe, against which resistance element fluid flows to generate vortices that are lined up to form a so-called Kármán vortex street within the partial volume of the fluid flow flowing directly downstream of the resistance element. As is known, the vortices are generated at the resistance element at a separation rate (1/fᵥₜₓ) that is dependent upon the flow velocity.

Furthermore, the measuring systems have a sensor that is integrated into the resistance element or connected therewith or downstream thereof, viz., in the region of the Kármán vortex street in the flow, thus in lumens of the projecting (vortex) sensor, which sensor is used to detect pressure fluctuations in the Karman vortex street formed in the flowing fluid and to convert them into a sensor signal representing the pressure fluctuations, viz., to supply a-here, for example, electrical or capacitive-electrical-signal that corresponds to a pressure prevailing within the fluid, which, due to opposing vortices, is subjected to periodic fluctuations downstream of the resistance element, or has a signal frequency (~fᵥₜₓ) corresponding to the separation rate of the vortices.

For this purpose, the sensor has a (mechanical) sensor assembly formed by means of a substantially membrane-like, substantially disc-shaped, thin deformation body made of metal (measuring membrane) and a sensor lug (“paddle”) extending from a substantially planar surface of the deformation body-usually rod-shaped, plate-shaped, wedge-shaped, or paddle-shaped-which is designed to measure pressure fluctuations in the Karman vortex street, viz., to convert it into movements of the deforming body corresponding to the pressure fluctuations. In particular, the deformation body and the sensor lug are designed to be excited by (alternating) forces acting upon the sensor lug, which are dependent upon the pressure fluctuations, to forced vibrations around a common static rest position, such that the sensor lug executes pendulum movements which elastically deform the deformation body.

The deformation body has an outer edge segment-usually circular-ring-shaped-which is configured to be hermetically sealed, e.g., integrally bonded, to a socket which is used to hold the deformation body on a wall of a tube such that the deformation body covers and hermetically seals an opening provided in the wall of the tube and that the surface, supporting the sensor lug, of the deformation body faces the fluid-carrying lumen of the measurement tube or of the pipe, and therefore the sensor lug projects into said lumen. In addition, the deformation body is shaped such that at least one (deformation body) thickness, measured as a smallest thickness of an inner (deformation body) segment bounded by the outer edge segment, is much less than a (deformation body) diameter, measured as a largest diameter of a surface bounded by the outer edge segment. In order to achieve the highest possible measurement sensitivity, viz., a highest possible sensitivity of the sensor to the pressure fluctuations to be detected and, at the same time, an as high as possible mechanical natural or resonant frequency, which is above the highest separation rate to be measured, for the (bending) vibration mode of the sensor assembly, which is excited by the pressure fluctuations (apart from resonance), such deformation bodies of established measuring systems typically have a diameter-to-thickness ratio which is approximately on the order of 20:1. In order to make such sensors or measuring systems formed with them (despite the relatively high diameter-to-thickness ratio of the respective deformation body required by the measuring principle) also suitable for applications with high operating pressures of more than 10 bar and/or with high operating temperatures of more than 100 °C—such as hot steam applications with (measurement medium) temperatures of at least temporarily over 200 °C and (measurement medium) pressures of at least temporarily more than 100 bar or other applications subject to relevant pressure equipment directives, such as Directive 97/23/EC, 14 ProdSV, ASUE U-Stamp, or 2014/68/EU—the measuring systems shown in US-B 97 19 819 also have a flange-shaped support device with a radial edge section and a cylindrical axial section, such that the deformation body, when a predetermined (increased) pressure is applied thereto, is supported against the support device, or measuring systems shown in US-B 1 08 45 222 further comprise an overload protection device serving to protect the deformation body against plastic or irreversible deformation with a support bracket guided at a lateral distance from the sensor lug and two stops for the sensor lug held by the support bracket. Furthermore, US-B 1 09 48 321 shows measuring systems (suitable for high temperatures or high pressures) in which the deformation body is shaped in order to achieve a high compressive strength in such a way that at least one region of its previously designated surface carrying the sensor lug, which is adjacent to the sensor lug, is convex. As shown, inter alia, in US-A 60 03 384, sensor assemblies of the aforementioned type can also have a usually rod-shaped, planar, or sleeve-shaped compensating element that extends from a surface, facing away from the surface supporting the sensor lug, of the deformation body and is used in particular to compensate for forces or moments resulting from movements of the sensor assembly, e.g., as a result of vibrations of the pipe, or to avoid undesired movements of the sensor lug resulting therefrom.

For the purpose of generating the sensor signal, the respective sensor of the aforementioned measuring systems further comprises a corresponding converter element positioned directly on the aforementioned surface, facing away from the surface carrying the sensor lug, of the deformation body and/or in the vicinity thereof. The converter element is formed by means of a (measuring) capacitor with variable (measuring) capacitance that is mechanically coupled to the respective deformation body and is designed to detect movements of the deformation body or of the compensation body, if present, e.g., via a corresponding change in the measuring capacitance, and to modulate an electrical carrier signal.

On a side facing away from the fluid-carrying lumen, the sensor assembly or the sensor formed therewith is furthermore connected to a transducer electronics system, which is typically encapsulated in a pressure-tight and impact-proof manner and optionally also hermetically sealed towards the outside. The transducer electronics of measuring systems which are suitable for industrial applications usually have a corresponding digital measurement circuit, which is electrically connected to the transducer element via connection lines, optionally with the interposition of electrical barriers and/or galvanic isolation points or feedthroughs, for processing the at least one sensor signal generated by the transducer element and for generating digital measurement values for the measured variable to be detected in each case, viz., the flow velocity, the volume flow rate, and/or the mass flow rate. The transducer electronics system, usually accommodated in a protective housing made of metal and/or impact-resistant plastic, of measuring systems suitable for industry or established in industrial measurement technology also usually provide external interfaces conforming to an industry standard, e.g., DIN IEC 60381-1, for communication with higher-level measurement and/or regulator systems—for example, formed by means of programmable logic controllers (PLC's). Such an external interface can be designed, for example, as a two-wire connection that can be incorporated into a current loop and/or be compatible with established industrial field buses.

One disadvantage of measuring systems of the aforementioned type is that their respective sensors can and do regularly have a comparatively high or comparatively broadband (cross-) sensitivity to interfering vibrations coupled in via the pipe due to a comparatively high proportion of moving mass (due to the measuring principle) and its unfavorable spatial distribution, accompanied by an unfavorable mechanical connection to the respective pipe; this is regularly also in such a way that corresponding (broadband) interfering vibrations of the sensor contacted by the measurement medium also have frequencies in the range of the aforementioned detachment rate of the vortices, possibly also with the amplitudes of the aforementioned vibration amplitudes comparable to the movements of the deforming body (corresponding to pressure fluctuations induced by vortices). A further disadvantage of such measuring systems is the high technical effort required for the construction of the (capacitive) converter element as well as the electrical connection of the converter element to the respective converter electronics, not least the cabling required for this.

Based upon this, one object of the invention is to simplify the construction of sensors of the type in question and also to improve them so that they have, on the one hand, high pressure and temperature resistance and, on the other, high measurement sensitivity; this is particularly the case with correspondingly high operating pressures or temperatures and/or with, at the same time, low cross-sensitivity to any interference vibrations coupled in via the pipe.

To achieve the object, the invention consists of a (capacitive) sensor element—e.g., a sensor element for (capacitive) detection of pressure fluctuations in a Kármán vortex street, formed in a flowing fluid, and/or a sensor element which is designed to be contacted by a flowing fluid-which sensor element comprises:
a base body, e.g., sleeve-shaped and/or monolithic, e.g., made of an electrically conductive material and/or a metal, with a (base body) cavity having an, e.g., circular, open first end and an, e.g., circular, open second end;
a deformation body, e.g., paddle-shaped and/or monolithic and/or serving as a sensor lug, made of an electrically conductive material, e.g., having an electrical conductivity of more than 105 S/m at an (operating) temperature of 20 °C, e.g., a metal, with a (deformation body) cavity having an, e.g., circular, open first end and a closed second end—for example, formed as a blind hole;
a reference body, e.g., rod-shaped and/or monolithic, made of an electrically conductive material, e.g., having an electrical conductivity of more than 10⁵ S/m at an (operating) temperature of 20 °C—for example, a metal;
and a, for example, sleeve-shaped and/or monolithic, filling body made of an electrically non-conductive material, e.g., an (insulating) material having an electrical conductivity of less than 10-8 S/m at an (operating) temperature of 20 °C, e.g., a glass, a plastic, or a ceramic, with a (filling body) cavity having, for example, a circular, open first end and a, for example, circular, open second end;
   wherein the reference body is partially embedded in the filling body in such a way that at least a first (reference body) sub-segment of the reference body is surrounded by the filling body, e.g., by forming a frictional connection and/or a form fit and/or a material bond, e.g., at least a second (reference body) sub-segment of the reference body adjacent to the same first reference body sub-segment is not surrounded by the filling body, and wherein the filling body is arranged together with the reference body (embedded therein) within the base body cavity in such a way that a (base body) surface, facing the lumen of the base body cavity, of the base body and a (filling body) surface, facing the same base body surface, of the filling body contact each other, e.g., by forming a frictional connection and/or a form fit and/or a material bond, and that the reference body and the base body are mechanically coupled to each other via the filling body, but are nevertheless galvanically separated from each other, e.g., electrically insulated, e.g., in such a way that a smallest electrical resistance R1 between reference body and base body at an (operating) temperature of 20 °C is not less than 10 MΩ—for example, is greater than 50 MΩ;
   wherein the deformation body and the base body are mechanically coupled to one another, forming a sensor cavity involving the deformation body cavity, e.g., a sensor cavity both involving the deformation body cavity and a partial region, not occupied by the filling body, of the base body cavity, in such a way that a first (base body) sub-segment, encompassing the first end of the base body cavity, of the base body and a first (deformation body) sub-segment, encompassing the first end of the deformation body cavity, of the deformation body are connected to one another, forming an electrically conductive, e.g., hermetically sealed, connection, e.g., in a materially bonded and/or form-fitting and/or force-fitting manner, and that the reference body, with the formation of an (annular) gap between the deformation body and the reference body, which is, for example, continuous and/or at least partially in the form of a hollow cylinder and/or not rotationally symmetrical, is arranged within the deformation body cavity proportionately, viz., with a free second reference body sub-segment (protruding out of the filling body or not surrounded by the filling body) adjacent to the first reference body sub-segment;
   wherein the reference body and the deformation body are arranged such that a (deformation body) inner surface, viz., a surface, facing (the lumen) of the deformation body cavity, e.g., a (circular) cylindrical surface, of the deformation body, and a (reference body) surface, facing the same deformation body inner surface, e.g., only partially (circular) cylindrical, of the reference body do not contact each other—for example, viz., in such a way that the reference body and the deformation body are galvanically separated from each other;
   and wherein the deformation body is designed to carry out vibrations around a static rest position, e.g., forced by (alternating) forces acting upon the deformation body, and to be moved relative to the reference body in such a way that the deformation body can carry out or does carry out (cantilever) vibrations which deform its (deformation body) cavity or the (annular) gap, thus changing a (sensor) capacitance C1 (of a capacitor formed by the deformation body, the filling body, and the reference body) which is measurable between the deformation body and the reference body, e.g., when the deformation body is in a static rest position, by not less than 5 pF and/or not more than 100 pF.

Furthermore, the invention also consists in a measuring system formed by means of such a sensor element and (measuring) electronics electrically connected to the same sensor element for measuring at least one measured variable, e.g., a flow parameter or a material parameter, of a fluid measurement medium, e.g., a gas and/or a liquid, which is guided, for example, in a pipe and/or at least temporarily has a (measurement medium) temperature of more than 100 °C and/or acts upon the deformation body (of the sensor element) with a pressure difference of more than 10 bar.

Furthermore, the invention also consists in using such a measuring system for measuring a flow parameter—e.g., a flow velocity and/or a volume flow rate and/or a mass flow rate—of a fluid measurement medium, e.g., a steam, flowing in a pipe—for example, acting upon the deformation body (of the sensor element) at a (measurement medium) temperature of more than 100 °C and/or with a pressure difference of more than 10 bar.

According to a first embodiment of the invention, it is further provided that the deformation body be designed to be contacted by a fluid, e.g., a liquid and/or a gas or another fluid, which is flowing and/or at least temporarily has a (fluid) temperature of more than 100 °C.

According to a second embodiment of the invention, it is further provided that the deformation body be designed to be surrounded by a flowing fluid, e.g., a liquid and/or a gas, formed, for example, into a Kármán vortex street—for example, to be elastically deformed by (alternating) forces exerted thereon by the fluid.

According to a third embodiment of the invention, it is further provided that the deformation body be designed to convert (alternating) forces acting upon it, e.g., exerted by a fluid flowing (around it) and/or introduced via first and second (deformation body) outer surfaces, into (cantilever) vibrations deforming the (deformation body) cavity or the (annular) gap.

According to a fourth embodiment of the invention, it is further provided that the deformation body be designed to convert (alternating) forces exerted transversely to the (main) flow direction by a fluid flowing in a (main) flow direction, e.g., due to pressure fluctuations within a Karman vortex street formed in the flowing fluid, into (cantilever) vibrations deforming the (deformation body) cavity or the (annular) gap in a vibration direction pointing, for example, transversely to the (main) flow direction and/or in the direction of a (main) measuring direction of the sensor element.

According to a fifth embodiment of the invention, it is further provided that the deformation body be designed to convert (alternating) forces exerted on it in a (main) measuring direction (of the sensor element) into (cantilever) vibrations deforming the (deformation body) cavity or the gap. Developing this embodiment of the invention, it is further provided that a smallest width of the gap run parallel to the (main) measuring direction or be able to be measured parallel to the (main) measuring direction, and/or that a largest width of the gap not run parallel to the (main) measuring direction or not be able to be measured parallel to the (main) measuring direction.

According to a sixth embodiment of the invention, it is further provided that the deformation body have a first (deformation body) outer surface, viz., a (first) surface facing away from the deformation body cavity, e.g., convex and/or partially (circular) cylindrical and/or partially flat, and a second (deformation body) outer surface, viz., a (second) surface facing away from the deformation body cavity, but nevertheless opposite the first (deformation body) outer surface—for example, convex and/or partially (circular) cylindrical and/or partially flat. Developing this embodiment of the invention, the first and second (deformation body) outer surfaces are further configured to be contacted by a, for example, flowing, fluid, e.g., a liquid and/or a gas—for example, in such a way that (alternating) forces generated by the fluid and causing (cantilever) vibrations deforming the (deformation body) cavity or the (annular) gap are introduced into the deformation body via the first and second (deformation body) outer surfaces.

According to a seventh embodiment of the invention, it is further provided that a (measuring) capacitor with a (sensor) capacitance C1 determined by the gap be formed by means of the deformation body, the filling body, and the reference body—for example, in such a way that the (measuring) capacitor has a (measuring) sensitivity in a (main) measuring direction ΔC1/AX of more than 1 pF/mm or is designed to respond to a 1 μm (deflection) movement ΔX of the deformation body in a (main) measuring direction with a change ΔC1 of more than 1 fF of the capacitance C1. Developing this embodiment of the invention, it is further provided that the sensor element be designed in such a way that the (measuring) capacitor, in a (main) measuring direction, has a, for example, greater than 1 pF/mm and/or greatest (measuring) sensitivity ΔC1/AX, such that the (measuring) capacitor is set up to respond to a (deflection) movement ΔX, e.g., of more than 1 μm, of the deformation body in a (main) measuring direction with a change ΔC1 of the capacitance C1, of, for example, more than 1 fF. Advantageously, the (measuring) capacitor can also have a cross-sensitivity ΔC1/AY that differs from the (measuring) sensitivity ΔC1/AX in a direction deviating from the (main) measuring direction, e.g., by not less than 50% of the (measuring) sensitivity ΔC1/AX, e.g., such that the cross sensitivity ΔC1/AY is smaller than the (measuring) sensitivity ΔC1/AX and/or that the (measuring) capacitor is set up to respond to a (deflection) movement ΔY of the deformation body in at least one, e.g., every, direction deviating from the (main) measuring direction with a change ΔC1′ of the capacitance C1, which is smaller than the change ΔC1 (of the capacitance C1) with which the (measuring) capacitor responds to an equal (deflection) movement ΔX of the deformation body in the (main) measuring direction.

According to an eighth embodiment of the invention, it is further provided that the deformation body in the static rest position and the reference body be arranged coaxially at least, e.g., only, in sections—for example, to form a capacitor.

According to a ninth embodiment of the invention, it is further provided that the reference body be at least, e.g., only, partially (circular-) cylindrical—for example, such that a smallest (cylinder) diameter of the second reference body sub-segment is greater than 3 mm and/or that a smallest (cylinder) diameter of the first reference body sub-segment is greater than a smallest (cylinder) diameter of the second reference body sub-segment.

According to a tenth embodiment of the invention, it is further provided that a smallest distance between the deformation body and the reference body be greater than 0.01 mm, e.g., greater than 0.1 mm, and/or less than 1 mm—for example, less than 0.5 mm.

According to an eleventh embodiment of the invention, it is further provided that a greatest distance between the deformation body and the reference body be greater than 14 0.02 mm, e.g., greater than 0.2 mm, and/or less than 10 mm—for example, less than 5 mm.

According to a twelfth embodiment of the invention, it is further provided that a smallest width of the (annular) gap (1′) be greater than 0.01 mm, e.g., greater than 0.1 mm, and/or smaller than 1 mm—for example, smaller than 0.5 mm.

According to a thirteenth embodiment of the invention, it is further provided that a greatest width of the (annular) gap (1′) be greater than 0.02 mm, e.g., greater than 0.2 23 mm, and/or smaller than 1 mm—for example, smaller than 0.5 mm.

According to a fourteenth embodiment of the invention, it is further provided that a largest width of the (annular) gap (1′) be more than 0.05 mm, e.g., more than 0.1 mm, larger than a smallest width of the (annular) gap (1′).

According to a fifteenth embodiment of the invention, it is further provided that the reference body have a (reference body) mass which is less than 10 g—for example, such that a (sub-segment) mass of the second reference body sub-segment is not more than 5 g and/or not more than 60% of the (reference body) mass.

According to a sixteenth embodiment of the invention, it is further provided that the deformation body have a smallest wall thickness which is not less than 0.2 mm and/or not greater than 1 mm.

According to a seventeenth embodiment of the invention, it is further provided that the deformation body have a (deformation body) mass which is less than 50 g and/or not less than 4 g—for example, such that the (deformation body) mass of the deformation body is greater than a (sub-segment) mass of the second reference body sub-segment.

According to an eighteenth embodiment of the invention, it is further provided that the deformation body have a (deformation body) length which is less than 50 mm and/or greater than 5 mm.

According to a nineteenth embodiment of the invention, it is further provided that the base body have a (base body) length which is greater than 5 mm and/or less than 100 mm—for example, not greater than 50 mm.

According to a twentieth embodiment of the invention, it is further provided that the filling body have a (filling body) length which is greater than 5 mm and/or less than 100 mm—for example, not greater than 50 mm.

According to a twenty-first embodiment of the invention, it is further provided that the reference body have a (reference body) length which is greater than 10 mm and/or less than 100 mm—for example, such that a (sub-segment) length of the second reference body sub-segment is less than 50 mm and/or more than 10 mm and/or less than 50% of the (reference body) length and/or more than 10% of the (reference body) length. Developing this embodiment of the invention, it is further provided that the base body, the reference body, or the filling body be designed such that the filling body length is smaller than the base body length and/or that the filling body length is smaller than the reference body length and/or that the base body length is smaller than the reference body length.

According to a twenty-second embodiment of the invention, it is further provided that the filling body be arranged within the base body cavity in such a way that a partial region, surrounded by the first base body sub-segment (forming the first end of the base body cavity), of the base body cavity is not filled by the filling body or is not occupied by the filling body.

According to a twenty-third embodiment of the invention, it is further provided that the reference body be embedded in the filling body in such a way that a third (reference body) sub-segment of the reference body, e.g., rod-shaped, which is adjacent to the first reference body sub-segment, but is nevertheless distant from the second (reference body) sub-segment, is not surrounded by the filling body. Developing this embodiment of the invention, it is further provided that the third (reference body) sub-segment (of the reference body) not be rotationally symmetrical with respect to an imaginary longitudinal axis of the same (reference body) sub-segment—for example, such that the third (reference body) sub-segment has a cross-section in the shape of a circular segment.

According to a twenty-fourth embodiment of the invention, it is further provided that the sensor element-which has a plurality of (natural) vibration modes in which the deformation body and/or the reference body each carry out or can carry out (mechanical) vibrations around a respective static rest position with a respective natural or resonant frequency—have a first vibration mode in which the deformation body can carry out or does carry out (cantilever) vibrations, e.g., having only a single vibration node, in a first vibration direction corresponding, for example, to a (main) measuring direction (of the sensor element), and a second vibration mode in which the reference body can carry out or does carry out (cantilever) vibrations, e.g., having only a single vibration node, in the same first vibration direction, and it is further provided that the natural frequency of the first vibration mode, which is for example more than 1,000 Hz and/or less than 10 KHz, deviate from the natural frequency of the second vibration mode, which is for example more than 1,000 Hz and/or less than 10 KHz, by less than 500 Hz and/or by not more than 10% of the natural frequency of the second vibration mode.

According to a twenty-fifth embodiment of the invention, it is further provided that the sensor element-which has a plurality of (natural) vibration modes in which the deformation body and/or the reference body each carry out or can carry out (mechanical) vibrations around a respective static rest position with a respective natural or resonant frequency—have
a first vibration mode in which the deformation body can carry out or does carry out (cantilever) vibrations, e.g., having only a single vibration node, in a first vibration direction corresponding, for example, to a (main) measuring direction (of the sensor element), 14
a second vibration mode in which the reference body can carry out or does carry out (cantilever) vibrations, e.g., having only a single vibration node, in the same first vibration direction,
and a third vibration mode in which the deformation body can carry out or does carry out (cantilever) vibrations, e.g., having only a single vibration node, in a second vibration direction pointing perpendicularly to the first vibration direction, and a fourth vibration mode in which the reference body can carry out or does carry out (cantilever) vibrations, e.g., having only a single vibration node, in the same second vibration direction, and it is further provided
   that the natural frequency of the first vibration mode, which is for example more than 1,000 Hz and/or less than 10 KHz, deviate from the natural frequency of the second vibration mode, which is for example more than 1,000 Hz and/or less than 10 kHz, by less than 500 Hz and/or by not more than 10% of the natural frequency of the second vibration mode, and/or
   that the natural frequency of the third vibration mode, which is for example more than 1,000 Hz and/or less than 10 KHz, deviate from the natural frequency of the fourth vibration mode, which is for example more than 1,000 Hz and/or less than 10 kHz, by less than 500 Hz and/or by not more than 10% of the natural frequency of the second vibration mode, and/or
   that the natural frequency of the third vibration mode, which is for example more than 1,000 Hz and/or less than 10 KHz, deviate from the natural frequency of the first vibration mode, which is for example more than 1,000 Hz and/or less than 10 KHz, by less than 500 Hz and/or by not more than 10% of the natural frequency of the first vibration mode, and/or
   that the natural frequency of the third vibration mode, which is for example more than 1,000 Hz and/or less than 10 KHz, deviate from the natural frequency of the second vibration mode, which is for example more than 1,000 Hz and/or less than 10 11 kHz, by less than 1,000 Hz and/or by not more than 20% of the natural frequency of the second vibration mode, and/or
   that the natural frequency of the fourth vibration mode, which is for example more than 1,000 Hz and/or less than 10 kHz, deviate from the natural frequency of the second vibration mode by less than 500 Hz and/or by not more than 10% of the natural frequency of the second vibration mode, and/or
   that the natural frequency of the fourth vibration mode, which is for example more than 1,000 Hz and/or less than 10 KHz, deviate from the natural frequency of the first vibration mode, which is for example more than 1,000 Hz and/or less than 10 KHz, by less than 1,000 Hz and/or by not more than 20% of the natural frequency of the first vibration mode.

According to a twenty-sixth embodiment of the invention, it is further provided that the first (reference body) sub-segment (of the reference body) have a (sub-segment) length which is greater than 10 mm and/or less than 100 mm.

According to a twenty-seventh embodiment of the invention, it is further provided that the second (reference body) sub-segment (of the reference body) have a (sub-segment) length which is greater than 10 mm and/or less than 100 mm.

According to a twenty-eighth embodiment of the invention, it is further provided that the second (reference body) sub-segment (of the reference body), e.g., to increase a mutual (frequency) distance of natural or resonant frequencies of different vibration modes of the sensor element and/or to increase a (measuring) sensitivity ΔC1/ΔX of a capacitor C1 formed by the deformation body, the filling body, and the reference body relative to a cross-sensitivity ΔC1/ΔY of the same capacitor C1, not be rotationally symmetrical with respect to an imaginary longitudinal axis of the same (reference body) sub-segment—for example, such that the second (reference body) sub-segment has a T-shaped cross-section.

According to a twenty-ninth embodiment of the invention, it is further provided that the base body be made of a material having a (linear) thermal expansion coefficient at an (operating) temperature of 20 °C of more than 5·10⁻⁶ K⁻¹, e.g., not less than more than 8·10⁻⁶ K⁻¹, and/or less than 25·10⁻⁶ K⁻¹—for example, not more than 19·10⁻⁶ K⁻¹.

According to a thirtieth embodiment of the invention, it is further provided that the reference body be made of a material having a (linear) thermal expansion coefficient at an (operating) temperature of 20 °C of less than 11·10⁻⁶ K⁻¹.

According to a thirty-first embodiment of the invention, it is further provided that the filling body be made of a material having a (linear) thermal expansion coefficient at an (operating) temperature of 20 °C of more than 5·10⁻⁶ K⁻¹, e.g., not less than 8·10⁻⁶ K⁻¹, and/or less than 25·10⁻⁶ K⁻¹—for example, not more than 19·10⁻⁶ K⁻¹.

According to a thirty-second embodiment of the invention, it is further provided that the filling body be made of a material having a (linear) thermal expansion coefficient at an (operating) temperature of 20 °C of more than 5·10⁻⁶ K⁻¹, e.g., not less than 8·10⁻⁶ K⁻¹, and/or less than 25·10⁻⁶ K⁻¹, e.g., not more than 19·10⁻⁶ K⁻¹, wherein the thermal expansion coefficient (of the material) of the base body is not smaller than the thermal expansion coefficient (of the material) of the reference body, e.g., such that the thermal expansion coefficient (of the material) of the base body at an (operating) temperature of 20 °C is more than 1·10⁻⁶ K⁻¹, e.g., no less than 5·10⁻⁶ K⁻¹, greater than the thermal expansion coefficient (of the material) of the reference body.

According to a thirty-third embodiment of the invention, it is further provided that the filling body be made of a material having a (linear) thermal expansion coefficient at an (operating) temperature of 20 °C of more than 5·10⁻⁶ K⁻¹, e.g., not less than 8·10⁻⁶ K⁻¹, and/or less than 25·10⁻⁶ K⁻¹, e.g., not more than 19·10⁻⁶ K⁻¹, wherein the thermal expansion coefficient (of the material) of the base body is not smaller than the thermal expansion coefficient (of the material) of the filling body, e.g., such that the thermal expansion coefficient (of the material) of the base body at an (operating) temperature of 20 °C is more than 1·10⁻⁶ K⁻¹, e.g., no less than 5·10⁻⁶ K⁻¹, greater than the thermal expansion coefficient (of the material) of the filling body.

According to a thirty-fourth embodiment of the invention, it is further provided that the filling body be made of a material having a (linear) thermal expansion coefficient at an (operating) temperature of 20 °C of more than 5·10⁻⁶ K⁻¹, e.g., not less than 8·10⁻⁶ K⁻¹, and/or less than 25·10⁻⁶ K⁻¹, e.g., not more than 19·10⁻⁶ K⁻¹, wherein the coefficient of thermal expansion (of the material) of the reference body is not greater than the coefficient of thermal expansion (of the material) of the filling body, e.g., such that the coefficient of thermal expansion (of the material) of the reference body is less than 1·10⁻⁶ K⁻¹ less than the thermal expansion coefficient (of the material) of the filling body.

According to a thirty-fifth embodiment of the invention, it is further provided that the base body be made, e.g., entirely, of a metal—for example, a (rust-proof) stainless steel (WNo. 1.4404).

According to a thirty-sixth embodiment of the invention, it is further provided that the reference body be made, e.g., entirely, of a metal—for example, a nickel-based alloy (WNo. 2.4475).

According to a thirty-seventh embodiment of the invention, it is further provided that the filling body consist at least partially, e.g., entirely, of a glass—for example, a melting gas.

According to a thirty-eighth embodiment of the invention, it is further provided that the sensor cavity be hermetically sealed.

According to a thirty-ninth embodiment of the invention, it is further provided that the base body and the filling body be connected to one another in a force-fitting manner at least at an (operating) temperature of less than 400 °C.

According to a fortieth embodiment of the invention, it is further provided that the filling body and the reference body be connected to one another in a force-fitting manner at least at an (operating) temperature of less than 400 °C.

According to a forty-first embodiment of the invention, it is further provided that the sensor cavity be filled with an (inert) gas—for example, nitrogen and/or a noble gas. Alternatively, the sensor cavity can also be evacuated.

According to a first development of the invention, the sensor element further comprises: a (first) connecting line electrically connected to the reference body—for example, electrically conductively connected thereto.

According to a second development of the invention, the sensor element further comprises: a (second) connecting line electrically connected to the base body—for example, electrically conductively connected thereto.

According to a first embodiment of the measuring system of the invention, the sensor element is further designed to respond to a pressure difference of 1 bar acting upon the deformation body in a (main) measuring direction (of the sensor element) with a change ΔC1 of the capacitance C1 of not less than 10 fF (femtofarad) and/or not more than 1 pF (picofarad).

According to a second embodiment of the measuring system of the invention, it is further provided that, by means of the deformation body, e.g., by means of the deformation body and the base body, a reference potential, e.g., zero, be provided for at least one (signal) voltage to be processed by means of the measuring electronics, or a ground (GND) of the measuring electronics be formed.

A basic idea of the invention is, among other things, to provide a (capacitive) sensor element with a high measurement sensitivity and a high pressure and/or temperature resistance by directly detecting (only) deformation movements of the deformation body relative to a (stationary) reference body placed within it, viz., without a (thin) measuring membrane and a compensating body that follows its vibration movements, and converting them (directly) into a change in the (sensor) capacitance or a corresponding (capacitive) electrical measurement signal. The sensor element according to the invention has a mechanical and electrical structure which is comparatively simple and robust, and which also advantageously has a very small moving mass (due to the measuring principle). In conjunction with this, the sensor element according to the invention advantageously also has a low cross-sensitivity to external interference vibrations—for example, those coupled in via a connected pipe.

The invention as well as advantageous embodiments thereof are explained in more detail below based upon exemplary embodiments shown in the figures of the drawing. Identical or identically acting or identically functioning parts are provided with the same reference signs in all figures; for reasons of clarity or if it appears sensible for other reasons, reference signs mentioned before are dispensed with in subsequent figures. Further advantageous embodiments or developments, especially, combinations of partial aspects of the invention that were initially explained only separately, furthermore emerge from the figures of the drawing and/or from the claims themselves. In the figures, in detail:

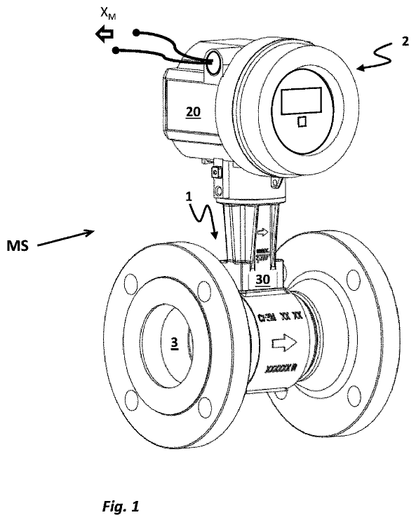

FIG. 1 shows a perspectival side view of an exemplary embodiment of a measuring system according to the invention;

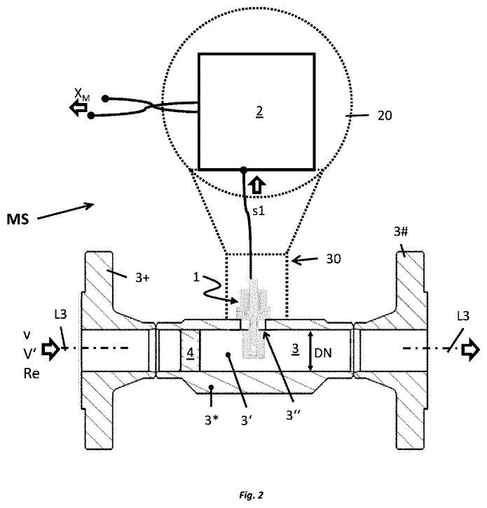

FIG. 2 shows a schematic, partly sectional side view of a measuring system according to FIG. 1;

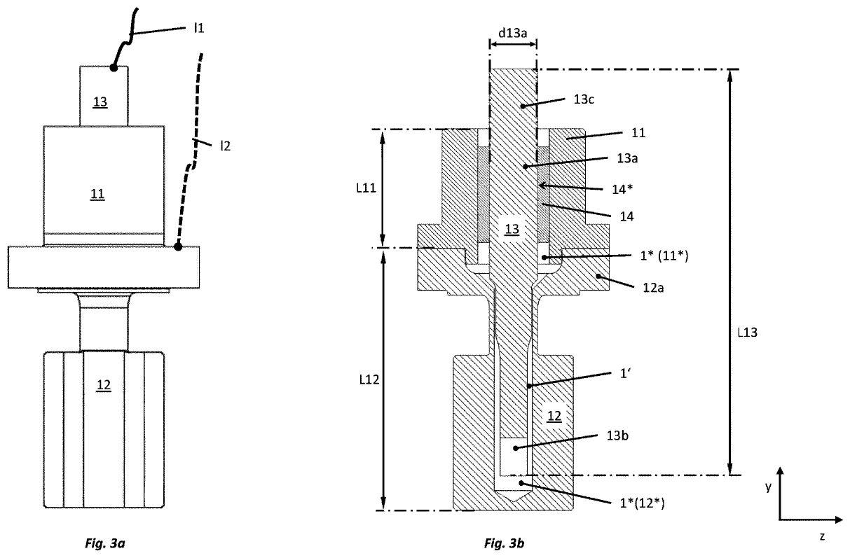

FIG. 3a shows a side view of an exemplary embodiment of a sensor element according to the invention or suitable for the measuring system according to FIG. 1 or 2;

FIG. 3b shows a sensor element according to FIG. 3a or 3b in a sectional side view;

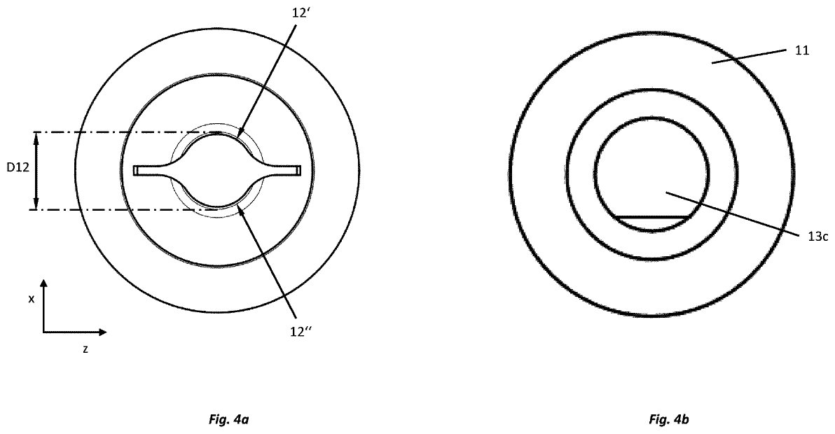

FIG. 4a, 4b show in further different side views a sensor element according to FIG. 3a or 3b;

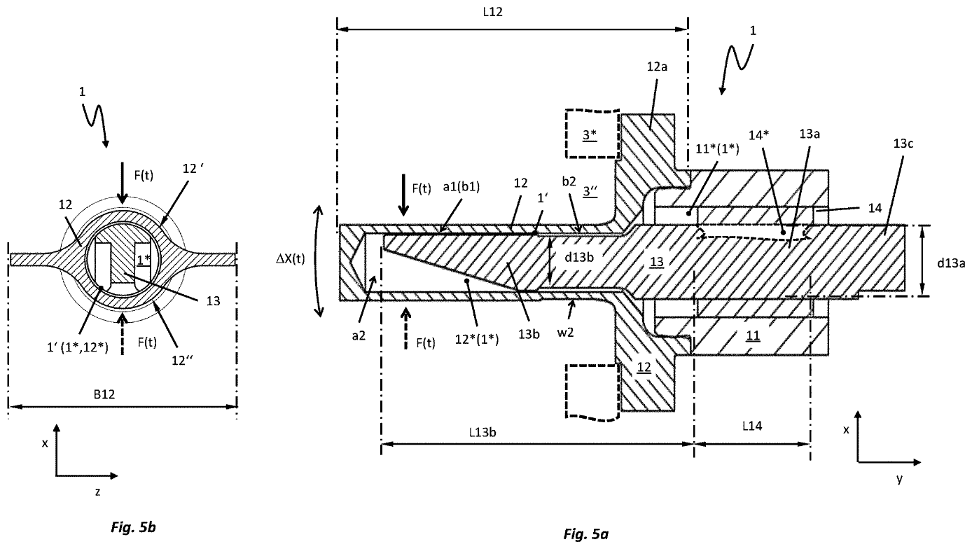

FIG. 5a, 5b show a sensor element according to FIG. 3a or 3b in different sectional side views;

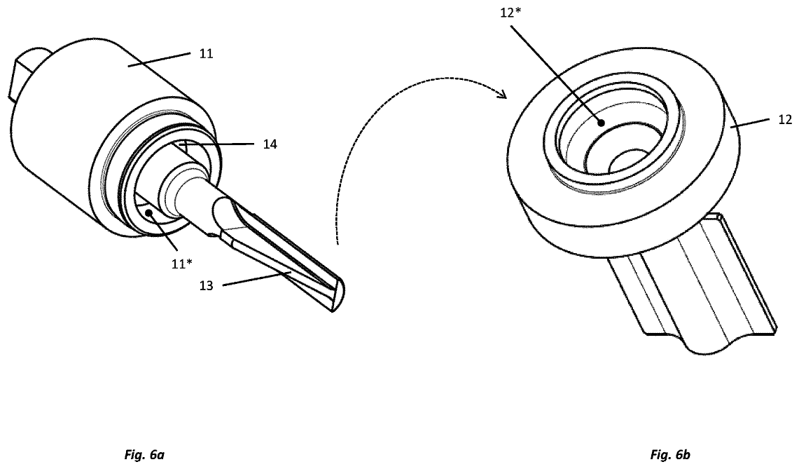

FIG. 6a shows a perspectival side view of components (base body, filling body, reference body) of a sensor element according to FIGS. 3a; and

FIG. 6b shows a perspectival side view of a deformation body of a sensor element according to FIG. 3a.

FIGS. 1 and 2 show an exemplary embodiment of a measuring system for measuring at least one flow parameter, possibly also variable over time, such as a flow velocity v and/or a volume flow rate V′, of a (measurement) fluid flowing in a pipe, e.g., a hot gas having, in particular, at least temporarily a temperature of more than 100 °C, and/or being at least temporarily under a high pressure, in particular, of more than 10 bar. The pipe can be designed, for example, as a plant component of a heat supply network or of a turbine circuit, and therefore the (measurement) fluid or the measurement medium can, for example, be steam, in particular saturated steam or superheated steam, or else, for example, (cooling) water or a condensate discharged from a steam line. However, (measurement) fluid can also, for example, be water, (compressed) natural gas, or a biogas or gaseous or liquefied hydrogen, so that the pipe can also be a component of a natural gas or biogas plant or of a high-pressure or liquid hydrogen plant or a gas supply network, for example.

The measuring system MS has a sensor element 1—shown again in various views in FIGS. 3a, 3b, 4a, 4b, 5a, 5b, 6a, and 6b, enlarged or partially sectioned-which (within the measuring system) can be provided or designed, for example, to detect pressure fluctuations in the (measurement) fluid flowing past the sensor element 1 in a (main) flow direction (of the measuring system MS) and to convert them into a (capacitive) electrical sensor signal s1 corresponding to the same pressure fluctuations. As is apparent from FIGS. 1 and 2 when viewed together, the measuring system furthermore comprises a (measuring) electronics system 2—for example, accommodated in a pressure-resistant and/or impact-resistant protective housing 20—which is connected to the sensor element 1 or communicates with the sensor element 1 during operation of the measuring system. The measurement electronics 2 is, especially, configured to receive and process the sensor signal s1, namely, for example, to generate measurement values XM representing the at least one flow parameter, i.e., for example, the flow velocity v or the volume flow rate V′. The measurement values XM can, for example, be visualized in situ and/or be transmitted in a wired manner via a connected fieldbus and/or in a wireless manner via radio to an electronic data processing system—for example, a programmable logic controller (PLC) and/or a process control station. The protective housing 20 for the measurement electronics 2 can, for example, be produced from a metal, such as stainless steel or aluminum, and/or by means of a casting method, such as an investment casting or die casting method (HPDC); it can, however, for example, also be formed by means of a plastic molded part produced in an injection-molding method.

The sensor element 1 comprises, as shown in FIGS. 3b and 5a respectively or as is readily apparent from a combination of FIGS. 3a, 3b, 4a, 4b, 5a, 5b, 6a, and 6b, an, in particular sleeve-shaped and/or monolithic, base body 11 with a (base body) cavity 11* having, for example, a circular, open first end and an, in particular for example, open, second end, an, in particular paddle-shaped and/or monolithic, (serving as a sensor lug) deformation body 12 with a (deformation body) cavity 12* having, in particular, a circular, open first end (12a) and a closed second end, in particular designed as a blind hole, an, in particular rod-shaped and/or monolithic, reference body 13 and an, in particular sleeve-shaped and/or monolithic, filling body 14 with a (filling body) cavity 14* having an, in particular circular, open first end and an, in particular circular, open second end. According to a further embodiment of the invention, the deformation body 12 is in particular intended or arranged to be contacted by (measurement) fluid during operation of the sensor or the measuring system formed thereby or to be flowed around by (measurement) fluid, flowing, for example, so as also to be formed into a Kármán vortex street, in particular in a (main) flow direction of the measuring system; this in particular in such a way that (alternating) forces (F) are exerted by the fluid on the deformation body 12 that (only) elastically deform the deformation body 12 or excite it to (cantilever) vibrations (ΔX). The reference body 13 can advantageously be designed to be (circular-) cylindrical at least in sections; for example, this can also be done in such a way that the reference body 13 is (circular-) cylindrical only in sections, as can also be seen from FIG. 6a.

According to a further embodiment of the invention, the base body 11 has a (base body) length L11 that is greater than 5 mm (millimeters) and/or less than 100 mm, in particular not greater than 50 mm, and/or the filling body has a (filling body) length L14 that is greater than 5 mm and/or less than 100 mm, in particular not greater than 50 mm, and/or the reference body 13 has a (reference body) length L13 that is greater than 10 mm and/or less than 100 mm. Alternatively or in addition, the filling body length can advantageously also be smaller than the base body length and/or smaller than the reference body length L13, and/or the base body length can advantageously be smaller than the reference body length. According to a further embodiment of the invention, the reference body has a (reference body) mass that is less than 10 g (grams), and/or the deformation body 12 has a (deformation body) mass that is not greater than 50 g and/or not less than 4 g.

The deformation body 12 and the reference body 13, and possibly also the base body 11, consist of electrically conductive material, in particular material that is highly conductive or has an electrical conductivity of more than 105 S/m (Siemens per meter) at a (operating) temperature of 20 °C, e.g., a metal, whereas the filling body 14 is made of electrically poorly or non-conductive material, in particular (insulating) material having an electrical conductivity of less than 10-8 S/m at an (operating) temperature of 20 °C—for example, a glass, a plastic, or a ceramic. Advantageously, the base body 11 and the deformation body 12 can, for example, also consist of the same material. The base body 11 and the deformation body 12 can, for example, also be components of one and the same monolithic molded part that is cast or produced by an additive manufacturing process such as 3-D laser melting, for example; however, the base body 11 and the deformation body 12 can also be designed as individual parts that are initially separate from one another and are only subsequently integrally bonded to one another, e.g., welded or soldered to one another, and therefore produced from materials that can correspondingly be integrally bonded to one another.

According to a further embodiment of the invention, the base body 11 is made of a material having a (linear) thermal expansion coefficient at an (operating) temperature of 20 °C of more than 5·10⁻⁶ K⁻¹, in particular not less than more than 8·10⁻⁶ K⁻¹, and/or less than 25·10⁻⁶ K⁻¹, in particular not more than 19·10⁻⁶ K⁻¹, and/or the reference body 13 is made of a material having a (linear) thermal expansion coefficient at an (operating) temperature of 20 °C of less than 11·10⁻⁶ K⁻¹, and/or the filling body 14 is made of a material having a (linear) thermal expansion coefficient at an (operating) temperature of 20 °C of more than 5·10⁻⁶ K⁻¹, in particular not less than 8·10⁻⁶ K⁻¹, and/or less than 29 25·10⁻⁶ K⁻¹, in particular not more than 19·10⁻⁶ K⁻¹, in particular in such a way that the thermal expansion coefficient (of the material) of the base body 11 is not smaller than the thermal expansion coefficient (of the material) of the reference body 13, and/or that the thermal expansion coefficient (of the material) of the base body is not smaller than the thermal expansion coefficient (of the material) of the filling body 14, and/or that the thermal expansion coefficient (of the material) of the reference body is not greater than the thermal expansion coefficient (of the material) of the filling body 14. Advantageously, the materials for the base body 11, reference body 13, or filling body 14 can also be selected such that the thermal expansion coefficient (of the material) of the base body at an (operating) temperature of 20 °C is more than 1·10⁻⁶ K⁻¹, in particular not less than 5·10⁻⁶ K⁻¹, greater than the thermal expansion coefficient (of the material) of the reference body 13, and/or that the thermal expansion coefficient (of the material) of the base body at an (operating) temperature of 20 °C is more than 1·10⁻⁶ K⁻¹, in particular not less than 5·10⁻⁶ K⁻¹, greater than the thermal expansion coefficient (of the material) of the filling body 14, and/or that the thermal expansion coefficient (of the material) of the reference body 13 is less than 1·10⁻⁶ K⁻¹ smaller than the thermal expansion coefficient (of the material) of the filling body 14. According to a further embodiment of the invention, the base body 11 is made at least partially, in particular entirely, of a metal, e.g., a (rust-proof) stainless steel (WNo. 1.4404), and/or the reference body 13 is made at least partially, in particular entirely, of a metal, e.g., a nickel-based alloy (WNo. 2.4475), and/or the filling body 14 is made at least partially, in particular entirely, of a glass—for example, a melting gas.

In the sensor element according to the invention, the reference body 13 is partially embedded in the filling body 14 such that at least a first (reference body) sub-segment of the reference body 13 is surrounded by the filling body, in particular by forming a frictional connection and/or a form fit and/or a material bond; in particular, at least a second (reference body) sub-segment of the reference body adjacent to the same first (reference body) sub-segment is not surrounded by the filling body; this is also done, for example, in such a way that the sensor element is intact at least up to an (operating) temperature of 400 °C, or that the reference body 13 and the filling body 14 are connected to one another in a frictional connection at least at an (operating) temperature of 400 °C or less. According to a further embodiment of the invention, the reference body 13 is designed and embedded in the filling body 14 such that the first (reference body) sub-segment 13a (of the reference body) has a (sub-segment) length that is greater than 10 mm and/or less than 100 mm, and/or that the second (reference body) sub-segment 13b (of the reference body) has a (sub-segment) length L13b that is greater than 10 mm and/or less than 100 mm, and/or a (sub-segment) mass that is not more than 5 g. Alternatively or in addition, a smallest (cylinder) diameter d13b of the aforementioned second reference body sub-segment 13b can be greater than 3 mm and/or advantageously be selected such that the smallest (cylinder) diameter d13b of the second reference body sub-segment 13b, as is also readily apparent from FIG. 5a or from a combination of FIGS. 3b and 5a, is smaller than a smallest (cylinder) diameter d13a of the first reference body sub-segment 13a, and/or the reference body can also be designed and embedded in the filling body 14 such that the aforementioned (sub-segment) length of the second reference body sub-segment is less than 50% of the (reference body) length and/or more than 10% of the (reference body) length.

Advantageously, the reference body 13 can also be designed and embedded in the filling body 14 in such a way that the aforementioned (deformation body) mass is greater than the aforementioned (sub-segment) mass of the second reference body sub-segment, and/or that the same (sub-segment) mass of the second reference body sub-segment is not more than 60% of the (reference body) mass.

According to a further embodiment of the invention, the reference body 13 is further embedded in the filling body in such a way that a third (reference body) sub-segment 13c, adjacent to the first reference body sub-segment 13a, but nevertheless remote from the second (reference body) sub-segment, e.g., (also) rod-shaped, of the reference body is not surrounded by the filling body 14 (in the same way as the aforementioned second reference body sub-segment). Advantageously, e.g., for easy marking of an installation position, the third (reference body) sub-segment 13c can be designed to be non-rotationally symmetrical with respect to an imaginary longitudinal axis of the same (reference body) sub-segment—for example, in such a way that the third (reference body) sub-segment 13c, as also indicated in FIG. 4b, has a circular segment-shaped or D-shaped cross-section.

The filling body 14 is arranged together with the reference body 13 (embedded therein) within the base body cavity 11* in such a way that a (base body) surface, facing the lumen of the base body cavity 11*, of the base body and a (filling body) surface, facing the same base body surface, of the filling body contact each other (forming a frictional connection and/or a form fit and/or a material bond), and that the reference body 13 and the base body 11 are mechanically coupled to each other via the filling body 14, but are galvanically separated from each other or electrically insulated from each other; for example, this is such that a smallest electrical resistance R1 between the reference body 13 and the base body 11 at an (operating) temperature of 20 °C is not less than 10 MΩ, in particular is greater than 50 MΩ, and/or that the base body 11 and the filling body 14 are force-fitted together, at least at an (operating) temperature of 400 °C. or less. According to a further embodiment of the invention, the filling body 14, not least for protection against mechanical overloading or damage, is further arranged within the base body cavity 11* in such a way that a partial region, surrounded by the first base body sub-segment (forming the first end of the base body cavity), of the base body cavity is not filled by the filling body 14 or is not occupied by the filling body 14. The base body and the reference body can advantageously be joined by means of primary forming to form the filling body within the base body cavity. The filling body can accordingly be formed, for example, directly within the base body in that, first, the reference body is placed within the base body cavity (corresponding to the installation position and location to be achieved) to form an (annular gap-shaped) gap at a distance from the base body, material useful for producing the filling body, e.g., in the form of granules and/or a melt, is placed in the gap, and the filling body is then formed directly within the base body cavity by solidification of initially at least partially liquid, e.g., partially or melted, (filling body) material in the aforementioned gap.

The deformation body 12 and the base body 11 are also mechanically coupled to one another to form a deformation body cavity 12*, e.g., a sensor cavity 1* (11*+12*) involving both the deformation body cavity and a partial region, not occupied by the filling body 14, of the base body cavity, in such a way that a first (base body) sub-segment, which encompasses the first end of the base body cavity, of the base body 11 and a first (deformation body) sub-segment, which encompasses the first end of the deformation body cavity, of the deformation body 12 are connected to one another to form an electrically conductive, in particular hermetically sealed, connection (in a materially bonded and/or form-fitting and/or force-fitting manner), and that the reference body 13, as shown in FIG. 5b or also from a combination of FIGS. 3b, 5a and 5b, is arranged proportionately, viz., with a free second reference body sub-segment 13b adjacent to the first reference body sub-segment 13a (protruding from the filling body 14 or not surrounded by the filling body 14), within the deformation body cavity 12, forming an in particular circumferential (annular) gap 1′ between the deformation body 12 and the reference body 13. According to a further embodiment of the invention, the deformation body 12 and the reference body 13 are further designed and arranged such that the deformation body 12 in the static rest position and the reference body 13 (forming a capacitor) are arranged coaxially at least in sections—for example, also in such a way that the deformation body 12 and the reference body 13 are arranged coaxially only in sections. Advantageously, furthermore, the sensor cavity 1* can be hermetically sealed, and/or the (annular) gap 1′ (as a whole) not be rotationally symmetrical. Alternatively or in addition, the (annular) gap 1′ can also be designed to be hollow-cylindrical at least in sections—for example, in such a way that the (annular) gap 1′ is only hollow-cylindrical in sections. In the aforementioned case in which the sensor cavity is hermetically sealed, it can also be evacuated (εᵣ@0 Hz=εᵣ=ε/ε₀=1) or, for example, filled with an (inert) gas, in particular a noble gas (He, Ar) and/or nitrogen (N).

As shown schematically in FIG. 2, the deformation body 12 and the reference body 13 of the sensor element according to the invention are further arranged such that a (deformation body) inner surface, viz., a (circular-) cylindrical surface, facing (the lumen) of the deformation body cavity 12*, of the deformation body 12 and a (reference body) surface, facing the same deformation body inner surface, e.g., only partially (circular-28) cylindrical, of the reference body 13 do not contact each other; this is also particularly in such a way that the reference body and the deformation body are galvanically separated from each other. According to a further embodiment of the invention, the reference body and the deformation body are arranged in particular such that a smallest distance a1 between the deformation body 12 and the reference body 13 is greater than 2 0.01 mm, e.g., also greater than 0.1 mm, and/or smaller than 1 mm, e.g., also smaller than 0.5 mm, and/or that a largest distance a2 between the deformation body 12 and the reference body 13 is greater than 0.02 mm, e.g., also greater than 0.2 mm, and/or smaller than 10 mm—for example, also smaller than 5 mm. Alternatively or in addition, reference body 13 and deformation body 12 can also advantageously be arranged such that a smallest width b1 of the (annular) gap 1′ is greater than 0.01 mm, in particular greater than 0.1 mm, and/or smaller than 1 mm, in particular smaller than 0.5 mm, and/or that a largest width b2 of the (annular) gap 1′ is greater than 0.02 mm, in particular greater than 0.2 mm, and/or smaller than 1 mm, in particular smaller than 0.5 11 mm, and/or that the aforementioned largest width b2 of the (annular) gap 1′ is more than 12 0.05 mm, in particular more than 0.1 mm, larger than the aforementioned smallest width b1 of the (annular) gap 1′. The nominal (measuring) capacitance C1 of the sensor element (in static rest position) can also, for example, based upon the following calculation rule,

$$C 1 = K 1 \cdot ε \cdot L 13 b \cdot {[ ln ( \frac{2 a 1 + d 13 b}{d 13 b} ) ]}^{- 1}$$

be approximately specified (in advance) or determined (subsequently), wherein the sensor element-specific (dimensionless) coefficient K1 is advantageously chosen to be not less than 0.5 and/or not greater than 3 or, in the case in which the sensor element 1 corresponds to an (ideal) cylinder capacitor, 2π amounts to (K1=2π=2·3.1415 . . . ).

According to a further embodiment of the invention, the deformation body 12 further has a first (deformation body) outer surface 12′, viz., a (first) surface facing away from the deformation body cavity 12*, e.g., at least partially convex and/or partially (circular) cylindrical and/or partially flat, and a second (deformation body) outer surface 12″, viz., a (second) surface facing away from the deformation body cavity 12*, but nevertheless opposite the first (deformation body) outer surface, in particular at least partially convex and/or partially (circular) cylindrical and/or partially flat and/or structurally identical to the first (deformation body) outer surface. The first and second (deformation body) outer surfaces are in particular designed to be contacted by the (measurement) fluid, such that (alternating) forces F(t) generated by the fluid, in particular deforming the (deformation body) cavity or the (annular) gap 1′ and causing (cantilever) vibrations, are introduced into the deformation body via the first and second (deformation body) outer surfaces. The aforementioned first and second (deformation body) outer surfaces can advantageously also be designed and arranged such that at least one surface normal of the first outer surface is aligned with an opposite surface normal of the second outer surfaces, or that surface normals of the first and second outer surfaces run parallel to one another, in particular are coincident. The deformation body 12 can also be externally designed, as is quite common with such sensors or measuring systems formed therewith, for example, to be wedge-shaped or at least partially plate-shaped; for example, this can also be done in such a way that the aforementioned first and second outer surfaces are at least partially (plane-) parallel and/or at least partially anti-parallel.

In the sensor element according to the invention, the deformation body 12 is also particularly designed to carry out vibrations around a static rest position, e.g., forced by (alternating) forces acting upon the deformation body 12, and thereby to be elastically deformed or moved relative to the reference body 13, such that the deformation body 12 can carry out or does carry out (cantilever) vibrations ΔX (t) which deform its (deformation body) cavity 12* or the (annular) gap 1′, thus changing a (sensor) capacitance C1 (of a capacitor formed by the deformation body 12, the filling body 14, and the reference body 13) that is measurable between the deformation body 12 and the reference body 13, in particular when the deformation body is in a static rest position, and amounts to no less than 5 pF and/or no more than 100 pF.

The aforementioned (alternating) forces F(t) exerted on the deformation body 12 can, as already indicated, be generated, for example, by the (measurement) fluid contacting or flowing around the deformation body 12, or be introduced via the aforementioned first and second (deformation body) outer surfaces. For electrical connection to the aforementioned (measuring) electronics 2, the sensor element 1 according to a further embodiment further comprises a (first) connecting line 11 which is electrically connected to the reference body 13, in particular electrically conductively connected thereto. In addition, the sensor element can also have, for example, a further (second) connection line 12 which also serves for the electrical connection to the (measuring) electronics, which can advantageously be electrically connected to the base body 11 or electrically conductively connected thereto. Alternatively or in addition, a reference potential, e.g., zero, for at least one (signal) voltage to be processed by the measuring electronics can be provided by means of the deformation body 12 or by means of the deformation body 12 and the base body 11, or, advantageously, a ground (GND) of the measuring electronics 2 can also be formed.

According to a further embodiment of the invention, the deformation body 12 is also particularly designed to convert (alternating) forces F(t) exerted transversely to the (main) flow direction by the (measurement) fluid flowing in a (main) flow direction (of the measuring system), e.g., due to pressure fluctuations within a Kármán vortex street formed in the flowing fluid, into (cantilever) vibrations x(t) deforming the (deformation body) cavity or the (annular) gap 1′ in a direction of vibration, in particular transversely to the (main) flow direction z and/or in the direction of a (main) detection or measuring direction x of the sensor element 1. The sensor element 1 or the measuring system formed thereby can advantageously be designed or aligned such that a smallest width of the gap 1′ runs parallel to the aforementioned (main) measuring direction x or can be measured parallel to the (main) measuring direction x, and/or that a largest width of the gap 1′ does not run parallel to the aforementioned (main) measuring direction x or cannot be measured parallel to the (main) measuring direction x. Alternatively or in addition, the sensor element can advantageously be arranged such that the surface normals of the aforementioned first and second (deformation body) outer surfaces are aligned at least partially parallel to the aforementioned (main) measuring direction x and/or at least partially orthogonal to the aforementioned (main) flow direction z.

According to a further embodiment of the invention, the deformation body 12 further has a (deformation body) thickness D12, measured as a maximum extension (of the deformation body 12) in the direction of the aforementioned (main) detection direction x of the sensor element 1 or as the greatest distance between the aforementioned first and second outer surfaces, which is significantly smaller than a (deformation body) length L12 of the deformation body 12, measured as a (maximum) extension (of the deformation body 12) in the direction (y) of the aforementioned base body length L11 or reference body length L13, or as a smallest distance between the aforementioned open first end of the deformation body cavity 12* and the aforementioned closed second end of the deformation body cavity 12*, plus the local wall thickness of the deformation body 12. In addition, the deformation body 12 has a (deformation body) width B12, measured in a direction (z) that is orthogonal to both the direction (x) of the (deformation body) thickness D12 and the direction (y) of the (deformation body) length L12, which width is greater than the (deformation body) thickness D12. Advantageously, the (deformation 12 body) width B12 can also be selected so that it is smaller than the (deformation body) length L12. Alternatively or additionally, the (deformation body) length L12 is not less than 5 mm and/or not more than 50 mm, and/or the deformation body 12 has a smallest (deformation body) wall thickness w12 which is not less than 0.2 mm and/or not greater than 1 mm. Advantageously, the deformation body 12 can also be designed or arranged such that the aforementioned smallest (deformation body) wall thickness w12 is located within at least one sub-segment of the deformation body 12 adjacent to the lumen of the deformation body cavity 12* and comprising one of the aforementioned first and second outer surfaces, or is measured in the aforementioned (main) detection direction x of the sensor element 1.

As already indicated, in the sensor element according to the invention, a (measuring) capacitor is formed in particular by means of the deformation body 12, the filling body 14, and the reference body 13; this in particular in such a way that the same (measuring) capacitor has a (sensor) capacitance C1 which is also determined by the (annular) gap. According to a further embodiment of the invention, the (measuring) capacitor has, in the aforementioned (main) measuring direction, a (measuring) sensitivity ΔC1/ΔX of more than 1 pF/mm (picofarad per millimeter), or the (measuring) capacitor is set up to respond to a 1 μm (micrometer) (deflection) movement ΔX of the deformation body 12 in the above-mentioned (main) measuring direction with a change ΔC1 of the capacitance C1 of more than 1 fF (femtofarad). Advantageously, the (measuring) capacitor or the sensor element formed therewith can also be designed in such a way that the capacitor has a greatest (measuring) sensitivity ΔC1/ΔX, in particular of more than 1 pF/mm, in the aforementioned (main) measuring direction; this in particular in such a way that the (measuring) capacitor responds to a (deflection) movement ΔX of more than 1 μm and/or less than 5 μm of the deformation body 12 in the above-mentioned (main) measuring direction with a change ΔC1 of the capacitance C1 of more than 1 fF. Alternatively or in addition, the (measuring) capacitor or the sensor element formed therewith can advantageously be designed such that the (measuring) capacitor, in a direction deviating from the (main) measuring direction, has a cross-sensitivity ΔC1/ΔY that differs from the (measuring) sensitivity ΔC1/ΔX, e.g., by not less than 50% of the (measuring) sensitivity ΔC1/ΔX; this in particular also in such a way that the cross-sensitivity ΔC1/ΔY, in particular by not less than 50% of the (measuring) sensitivity ΔC1/ΔX, is smaller than the (measuring) sensitivity ΔC1/ΔX, and/or that the (measuring) capacitor responds to a (deflection) movement ΔY, in particular of more than 1 μm of the deformation body 12 in at least one, in particular each, direction deviating from the (main) measuring direction with a change ΔC1′ of the capacitance C1, which is smaller than the change ΔC1 (of the capacitance C1) with which the (measuring) capacitor responds to a (deflection) movement ΔX of the deformation body 12 in (main) measuring direction x.

Due to its specific design, the sensor element 1 also has, among other things, a large number of (natural) vibration modes in which the deformation body 12 and/or the reference body 13 each carry out or can carry out mechanical vibrations about a respective static rest position with a respective (mechanical) natural or resonant frequency; this in particular in such a way that the sensor element 1 has a first vibration mode in which the deformation body 12 can carry out or does carry out (cantilever) vibrations in a first vibration direction, for example, also corresponding to the aforementioned (main) measuring direction (of the sensor element), and a second vibration mode in which the reference body 13 can carry out or does carry out (cantilever) vibrations in the same first vibration direction. The vibrations according to the first and/or second vibration modes can in particular also be designed such that they each have a natural frequency of more than 1,000 Hz (Hertz) and/or less than 10 KHz (Kilohertz), and/or only a single vibration node. According to a further embodiment of the invention, the deformation body 12 and the reference body 13 are further coordinated with one another, not least for the purpose of avoiding (interference) vibrations which change the (sensor) capacitance in an undesirable manner, e.g., with a frequency corresponding to one of the first and second natural frequencies, and thus falsify the actual measurement, such that the natural frequency of the first vibration mode deviates from the natural frequency of the second vibration mode by less than 500 Hz and/or by no more than 10% of the natural frequency of the second vibration mode. In addition to the aforementioned first and second vibration modes, the sensor element can also have a third vibration mode in which the deformation body 12 can carry out or does carry out (cantilever) vibrations, e.g., having only a single vibration node, in a second vibration direction pointing perpendicularly to the aforementioned first vibration direction, and the sensor element can also have a fourth vibration mode in which the reference body 13 can carry out or does carry out (cantilever) vibrations, e.g., having only a single vibration node, in the same second vibration direction. The vibrations according to the third and/or fourth vibration modes can, for example, be designed such that they each have a natural frequency of more than 1,000 Hz and/or less than 10 KHz; in order to avoid any interference vibrations that may be caused thereby; this is advantageously also done in such a way that the natural frequency of the third vibration mode deviates from the natural frequency of the fourth vibration mode by less than 500 Hz and/or by no more than 10% of the natural frequency of the second vibration mode, and/or that the natural frequency of the third vibration mode deviates from the natural frequency of the first vibration mode by less than 500 Hz and/or by no more than 10% of the natural frequency of the first vibration mode, and/or that the natural frequency of the third vibration mode deviates from the natural frequency of the second vibration mode by less than 1,000 Hz and/or by no more than 20% of the natural frequency of the second vibration mode, and/or that the natural frequency of the fourth vibration mode deviates from the natural frequency of the second vibration mode by less than 500 Hz and/or by no more than 10% of the natural frequency of the second vibration mode, and/or that the natural frequency of the fourth vibration mode deviates from the natural frequency of the first vibration mode deviates by less than 1,000 Hz and/or by not more than 20% of the natural frequency of the first vibration mode. The aforementioned natural frequencies can be specifically adjusted, for example, by appropriately selecting the (geometric) dimensions of reference body 13 and deformation body 12, in particular their respective lengths, the deformation body wall thickness, the deformation body thickness, or the reference body diameter, etc., as well as their respective materials or masses. According to a further embodiment of the invention, the second (reference body) sub-segment 13b (of the reference body 13), e.g., to increase a mutual (frequency) distance of natural or resonant frequencies of different vibration modes of the sensor element and/or to increase the aforementioned (measuring) sensitivity ΔC1/ΔX relative to the aforementioned cross-sensitivity ΔC1/ΔY, is not rotationally symmetrical with respect to an imaginary longitudinal axis of the same (reference body) sub-segment 13b—for example, also such that the second (reference body) sub-segment 13b, as also shown in FIG. 5b or 6a, has a T-shaped cross-section.

According to a further embodiment of the invention, the measurement system MS further comprises a tube 3 that can be inserted in the course of the aforementioned pipe and has a lumen 3′ that is surrounded by a wall 3*, e.g., a metallic wall, of the tube and extends from an inlet end 3+ to an outlet end 3 #and is configured to guide the fluid flowing in the pipe. In the exemplary embodiment shown in FIGS. 2 and 5a, at both the inlet end 3+ and the outlet end 3 #is a flange, which is used in each case to create a leak-free flange connection to a corresponding flange on an inlet-side or outlet-side line segment of the pipe. Furthermore, the tube 3 here is substantially straight, viz., for example, in the form of a hollow cylinder with a circular cross-section, in such a way that the tube 3 has an imaginary, straight longitudinal axis L3 connecting the inlet end 3+ and the outlet end 3 #. The sensor element 1 is inserted from the outside through an opening 3″ formed in the wall into the lumen of the tube 3 and is fixed in the region of the same opening—e.g., also detachably again—from the outside to the wall 3*, in such a way that the deformation body 12 projects into the same lumen. In particular, the sensor element 1 is inserted into the opening 3″ in such a way that a substantially membrane-shaped (deformation body) sub-segment 12a of its deformation body 12 covers or hermetically seals the opening 3″. Said opening 3″ can also be designed, for example, in such a way that it has, as is quite usual in measuring systems of the type in question, an (inner) diameter in a range of between 10 mm and ca. 50 mm. According to a further embodiment of the invention, a socket used to hold the sensor element 1 or deformation body 12 thereof on the wall 3* is also formed in the opening 3″. In this case, the sensor element 1 can, for example, be fixed to the tube 3 by integral bonding, in particular by welding or soldering, of the deformation body 12 and wall 3*; however, it can for example also be detachably connected to the tube 3, viz., for example, screwed thereto or screwed thereon. Furthermore, at least one sealing face, e.g., also a circumferential or circular-ring-shaped sealing face, can be formed in the aforementioned socket and is configured to seal the opening 3″ correspondingly in cooperation with the deformation body 12 or its aforementioned (deformation body) sub-segment 12a and an optionally provided, e.g., annular or annular disk-shaped, sealing element. Not least for the above-described case in which the sensor element 1 is inserted into the above-described holder and/or the deformation body 12 is to be connected in a materially bonded manner to the wall 3* of the tube 3, a further sealing surface matching the sealing surface, e.g., in the form of a circular ring, can advantageously be formed into the deformation body 12 or its (deformation body) sub-segment 12a in an edge region (outer, or corresponding to the above-described sealing surface of the holder).

In the exemplary embodiment shown in FIG. 2, the measuring system is specifically designed as a vortex flow meter with a resistance element 4 arranged in the lumen of the tube 3—here, viz., upstream of the (installed) sensor element 1—and serving to bring about a Karman vortex street in the flowing fluid. Here, the sensor element 1 and the resistance element 4 are, in particular, dimensioned and arranged such that the deformation body 12 projects into the lumen 3* of the tube 3, or into the fluid conducted therein, in such a region which, during operation of the measuring system, is regularly taken up by a (stationarily formed) Karman vortex street, so that the alternating forces acting upon the deformation body 12 or the pressure fluctuations detected by means of the sensor 1 are periodic pressure fluctuations caused by vortices, shed at the resistance element 4 at a separation rate (~1/fᵥₜₓ), and the sensor signal s1 has a signal frequency (~fᵥₜₓ) corresponding to the separation rate of said vortices. In the exemplary embodiment shown here, the measuring system is, moreover, designed as a compact-type measuring system or vortex flow meter in which the measurement electronics system 2 is accommodated in a protective housing 20 held on the tube 3—for example, by means of a neck-like connection piece 30. According to a further embodiment of the invention, the sensor element 1 and the tube 3 are further dimensioned such that the aforementioned deformation body length L12 corresponds to more than half of a caliber DN of the tube 3 or less than 95% of the same caliber DN. The deformation body length L12 can, for example—as is quite usual with a comparatively small caliber of less than 50 mm, or as can also be seen from FIG. 2—also be selected such that a free end of the deformation body 12 corresponding to the aforementioned second end of the deformation body cavity 12 also is at only a very small minimal distance from the wall 3* of the tube 3. In the case of tubes with a comparatively large caliber of 50 mm or more, the deformation body length L12 can also, as is quite usual in the case of measuring systems of the type in question, be significantly shorter than half of a caliber DN of the tube 3, for example.

1-33. (canceled)

34. A sensor element for detection of pressure fluctuations in a Kármán vortex street in a flowing fluid, the sensor element comprising:
a sleeve-shaped and/or monolithic base body made of an electrically conductive material, the base body defining a main cavity having an open first end and an open second end;
a paddle-shaped and/or monolithic deformation body operable as a sensor lug and made of an electrically conductive material, having an electrical conductivity of more than 105 S/m at a temperature of 20 °C, the deformation body defining a deformation body cavity having an open first end and a closed second end, which is configured as a blind hole;
a rod-shaped and/or monolithic reference body made of an electrically conductive material, having an electrical conductivity of more than 105 S/m at a temperature of 20 °C; and
a sleeve-shaped and/or monolithic filling body made of an electrically non-conductive, insulating glass, plastic, or ceramic material, having an electrical conductivity of less than 10-8 S/m at a temperature of 20 °C, the filling body defining a filling body cavity having an open first end and an open second end;
wherein the reference body is partially embedded in the filling body such that at least a first reference body sub-segment of the reference body is surrounded by the filling body, forming a frictional connection and/or a form fit and/or a material bond therebetween, and at least a free second reference body sub-segment of the reference body adjacent to the first reference body sub-segment is not surrounded by the filling body,
wherein the filling body is disposed with the reference body, which further embedded therein, within the base body cavity, such that:
a base body surface, facing a lumen of the base body cavity, of the base body and a filling body surface, facing the base body surface, of the filling body contact each other, forming a frictional connection and/or a form fit and/or a material bond; and
the reference body and the base body are mechanically coupled to each other via the filling body, but are electrically insulated from each other such that a smallest electrical resistance between the reference body and the base body at a temperature of 20 °C is not less than MΩ,
wherein the deformation body and the base body are mechanically coupled to each other as to define a sensor cavity, including both the deformation body cavity and a partial region, not occupied by the filling body, of the base body cavity, such that:
a first base body sub-segment, which encompasses the first end of the base body cavity, and a first deformation body sub-segment, which encompasses the first end of the deformation body cavity, are connected to each other, in a materially bonded and/or form-fitting and/or force-fitting manner, to form an electrically conductive connection; and
the reference body is arranged within the deformation body cavity as to form an annular gap, a circumferential gap and/or a hollow cylindrical gap, at least in sections, and/or a non-rotationally symmetrical gap, between the deformation body and the free second reference body segment, which projects from the filling body or is not surrounded by the filling body),
wherein the reference body and the deformation body are arranged such that a deformation body inner surface, facing a lumen of the deformation body cavity, and a reference body surface, facing the deformation body inner surface, do not contact each other such that the reference body and the deformation body are galvanically separated from each other, and
wherein the deformation body is configured to enable vibrations about a static rest position, forced by alternating forces acting upon the deformation body by the flowing fluid, and to be moved relative to the reference body such that the vibrations of the deformation body deform the deformation body cavity or the annular gap, thereby changing a sensor capacitance of a capacitor formed by the deformation body, the filling body, and the reference body, which sensor capacitance is measurable between the deformation body and the reference body and is not less than 5 pF and/or not more than 100 pF when the deformation body is in a static rest position.

35. The sensor element according to claim 34, wherein the deformation body is adapted to be contacted by the flowing fluid, which is a liquid and/or a gas and, at least temporarily, has a fluid temperature of more than 100 °C.

36. The sensor element according to claim 34, wherein the deformation body is adapted to be surrounded by the flowing fluid, which is a fluid and/or a gas, formed into a Kármán vortex street, and to be elastically deformed by the alternating forces exerted thereon by the fluid.

37. The sensor element according to claim 34, wherein the deformation body is configured to convert the alternating forces, introduced via first and second deformation body outer surfaces, into vibrations that deform the deformation body cavity or the annular gap.

38. The sensor element according to claim 34, wherein the deformation body is configured to convert the alternating forces exerted transversely to a flow direction of the flowing fluid into cantilever vibrations deforming the deformation body cavity or the annular gap in an vibration direction, which cantilever vibrations are transverse to the flow direction and/or are in the direction of a measuring direction of the sensor element, wherein the transverse alternating forces are due to pressure fluctuations within a Kármán vortex street formed in the flowing fluid.

39. The sensor element according to claim 34, wherein the deformation body has a first outer surface facing away from the deformation body cavity, which is a convex and/or partially cylindrical and/or partially flat surface, and a second outer surface facing away from the deformation body cavity and opposite the first outer surface, in particular, which second outer surface is convex and/or partially cylindrical and/or partially flat surface.

40. The sensor element according to claim 39, wherein the first outer surface and the second outer surface are embodied to be contacted by the flowing fluid, which is a liquid and/or a gas, wherein the first and second outer surfaces are configured such that alternating forces generated by the fluid and causing vibrations that deform the deformation body cavity or the annular gap are introduced into the deformation body via the first and second outer surfaces.

41. The sensor element according to claim 34, wherein the deformation body is adapted to convert alternating forces exerted thereon in a measuring direction of the sensor element into vibrations deforming the deformation body cavity or the annular gap.

42. The sensor element according to claim 41, wherein a smallest width of the gap extends parallel to the measuring direction or is measurable parallel to the measuring direction; and/or
wherein a largest width of the gap does not extend parallel to the measuring direction or cannot be measured parallel to the measuring direction.

43. The sensor element according to claim 34, wherein the sensor capacitance of the capacitor has a measuring sensitivity in a measuring direction of more than 1 pF/mm or is configured to respond to a 1 μm deflection movement of the deformation body in the measuring direction with a change of the capacitance of more than 1 fF.

44. The sensor element according to claim 43, wherein the measuring sensitivity in the measuring direction is greater than 1 pF/mm, and/or has a greatest measuring sensitivity, such that the capacitor is configured to respond to the deflection movement when greater of than 1 μm with a change of the capacitance of more than 1 fF.

45. The sensor element according to claim 44, wherein the capacitor has a cross-sensitivity in a direction deviating from the measuring direction, which differs from the measuring sensitivity by not less than 50% of the measuring sensitivity such that the cross sensitivity is smaller than the measuring sensitivity and/or such that the capacitor is configured to respond to a further deflection movement of the deformation body in at least one direction deviating from the measuring direction with a further change of the capacitance, which is smaller than the change of capacitance with which the capacitor responds to the equal deflection movement of the deformation body in the measuring direction.

46. The sensor element according to claim 34, wherein at least one of:
the deformation body in the static rest position and the reference body are arranged coaxially at least in sections;
the reference body is at least partially cylindrical such that a smallest diameter of the second reference body sub-segment is greater than 3 mm and/or a smallest diameter of the first reference body sub-segment is greater than a smallest diameter of the second reference body sub-segment;
a smallest distance between the deformation body and the reference body is greater than 0.01 mm and/or less than 1 mm;
a greatest distance between the deformation body and the reference body is greater than 0.02 mm and/or less than 10 mm;
a smallest width of the annular gap is greater than 0.01 mm and/or less than 1 mm;
a greatest width of the annular gap is greater than 0.02 mm and/or less than 1 mm;
the greatest width of the annular gap is more than 0.05 mm larger than the smallest width of the annular gap;
the reference body has a reference body mass which is less than 10 g such that a sub-segment mass of the second reference body sub-segment is not more than 5 g and/or not more than 60% of the reference body mass;
the deformation body has a smallest wall thickness which is not less than 0.2 mm and/or not greater than 1 mm;
the deformation body has a deformation body mass which is less than 50 g and/or not less than 4 g such that the deformation body mass is greater than the sub-segment mass of the second reference body sub-segment; and
the deformation body has a deformation body length that is less than 50 mm and/or greater than 5 mm.

47. The sensor element according to claim 46, wherein at least one of:
the smallest distance between the deformation body and the reference body is greater than 0.1 mm and/or less than 0.5 mm;
the greatest distance between the deformation body and the reference body is greater than 0.2 mm and/or less than 5 mm;
the smallest width of the annular gap is greater than 0.1 mm and/or less than 0.5 mm;
the greatest width of the annular gap is greater than 0.2 mm and/or less than 0.5 mm; and
the greatest width of the annular gap is more than 0.1 mm larger than the smallest width of the annular gap.

48. The sensor element according to claim 34, wherein at least on of:
the base body has a base body length that is greater than 5 mm and/or less than 100 mm;
the filling body has a filling body length that is greater than 5 mm and/or less than 100 mm;
the reference body has a reference body length which is greater than 10 mm and/or less than 100 mm such that a sub-segment length of the second reference body sub-segment is less than 50 mm and/or more than 10 mm and/or less than 50% of the reference body length and/or more than 10% of the reference body length.

49. The sensor element according to claim 48, wherein at least one of:
the filling body length is smaller than the base body length;
the filling body length is smaller than the reference body length; and
the base body length is smaller than the reference body length.

50. The sensor element according to claim 34, wherein the filling body is arranged within the base body cavity such that a partial region, surrounded by the first base body sub-segment is not filled by the filling body or is not occupied by the filling body.

51. The sensor element according to claim 34, wherein the reference body is embedded in the filling body such that a third reference body sub-segment of the reference body, adjacent to the first reference body sub-segment, yet remote from the second reference body sub-segment, is not surrounded by the filling body.

52. The sensor element according to claim 51, wherein the third reference body sub-segment is not rotationally symmetrical with respect to an imaginary longitudinal axis of the reference body sub-segment such that the third reference body sub-segment has a cross-section in the shape of a circular segment.

53. The sensor element according to claim 34, wherein the sensor element has a plurality of natural vibration modes in which the deformation body and/or the reference body each perform vibrations about a respective static rest position with a respective natural or resonant frequency.

54. The sensor element according to claim 52, wherein the sensor element has a first vibration mode in which the deformation body executes vibrations, having only a single vibration node, in a first vibration direction corresponding to a measuring direction of the sensor element and has a second vibration mode in which the reference body executes vibrations, having only a single vibration node, in the same first vibration direction; and
wherein the natural frequency of the first vibration mode, which is more than 1,000 Hz and/or less than 10 kHz, deviates from the natural frequency of the second vibration mode, which is more than 1,000 Hz and/or less than 10 kHz, by less than 500 Hz and/or by not more than 10% of the natural frequency of the second vibration mode.

55. The sensor element according to claim 54, wherein the sensor element has a third vibration mode in which the deformation body executes vibrations, having only a single vibration node, in a second vibration direction, which is perpendicular to the first vibration direction, and a fourth vibration mode in which the reference body executes vibrations, having only a single vibration node, in the second vibration direction.

56. The sensor element according to claim 55, wherein at least one of:
the natural frequency of the third vibration mode, which is more than 1,000 Hz and/or less than 10 kHz, deviates from the natural frequency of the fourth vibration mode, which is more than 1,000 Hz and/or less than 10 kHz, by less than 500 Hz and/or by not more than 10% of the natural frequency of the second vibration mode;
the natural frequency of the third vibration mode, which is more than 1,000 Hz and/or less than 10 kHz, deviates from the natural frequency of the first vibration mode, which is more than 1,000 Hz and/or less than 10 kHz, by less than 500 Hz and/or by not more than 10% of the natural frequency of the first vibration mode;
the natural frequency of the third vibration mode, which is more than 1,000 Hz and/or less than 10 kHz, deviates from the natural frequency of the second vibration mode, which is more than 1,000 Hz and/or less than 10 kHz, by less than 1,000 Hz and/or by not more than 20% of the natural frequency of the second vibration mode;
the natural frequency of the fourth vibration mode, which is more than 1,000 Hz and/or less than 10 kHz, deviates from the natural frequency of the second vibration mode by less than 500 Hz and/or by not more than 10% of the natural frequency of the second vibration mode; and
the natural frequency of the fourth vibration mode, which is more than 1,000 Hz and/or less than 10 kHz, deviates from the natural frequency of the first vibration mode, which is more than 1,000 Hz and/or less than 10 kHz, by less than 1,000 Hz and/or by not more than 20% of the natural frequency of the first vibration mode.

57. The sensor element according to claim 34, wherein at least one of:
the first reference body sub-segment has a sub-segment length that is greater than 10 mm and/or less than 100 mm;
the second reference body sub-segment has a sub-segment length which is greater than 10 mm and/or less than 100 mm; and
the second reference body sub-segment, for increasing a mutual frequency distance of natural or resonant frequencies of different vibration modes of the sensor element and/or for increasing a measuring sensitivity of the capacitor relative to a cross-sensitivity of the capacitor, is not rotationally symmetrical with respect to an imaginary longitudinal axis of the reference body sub-segment such that the second reference body sub-segment has a T-shaped cross-section.

58. The sensor element according to claim 34, wherein at least one of:
the base body is made of a material having a thermal expansion coefficient at a temperature of 20 °C of more than 5·10⁻⁶ K⁻¹ and/or less than 25·10⁻⁶ K⁻¹;
the reference body is made of a material having a thermal expansion coefficient at a temperature of 20 °C of less than 11·10⁻⁶ K⁻¹; and
wherein the filling body is made of a material having a thermal expansion coefficient at a temperature of 20 °C of more than 5·10⁻⁶ K⁻¹ and/or less than 25·10⁻⁶ K⁻¹.

59. The sensor element according to claim 58, wherein at least one of:
the thermal expansion coefficient of the base body at a temperature of 20 °C is not less than more than 8·10⁻⁶ K⁻¹ and/or not more than 19·10⁻⁶ K⁻¹; and
the thermal expansion coefficient of the filling body at a temperature of 20 °C is not less than 8·10⁻⁶ K⁻¹ and/or not more than 19.106 K⁻¹.

60. The sensor element according to claim 34, wherein at least one of:
the thermal expansion coefficient of the material of the base body is not less than the thermal expansion coefficient of the material of the reference body such that the thermal expansion coefficient of the base body at a temperature of 20 °C is greater by more than 1·10⁻⁶ K⁻¹ than the thermal expansion coefficient of the reference body;
wherein the thermal expansion coefficient of the base body is not less than the thermal expansion coefficient of the material of the filling body such that the thermal expansion coefficient of the base body at a temperature of 20 °C is greater by more than 1·10⁻⁶ K⁻¹ than the thermal expansion coefficient of the reference body; and
wherein the coefficient of thermal expansion of the reference body is not greater than the coefficient of thermal expansion of the filling body such that the coefficient of thermal expansion of the reference body smaller by less than 1·10⁻⁶ K⁻¹ than the thermal expansion coefficient of the filling body.

61. The sensor element according to claim 34, wherein at least one of:
the base body is made of a stainless steel;
the reference body is made of a nickel-based alloy;
the filling body is made, at least partially, of a glass;
the sensor cavity is hermetically sealed;
the base body and the filling body are connected to each other in a force-fitting manner performed at least at a temperature of less than 400 °C, and
the filling body and the reference body are connected to each other in a force-fitting manner performed at least at a temperature of less than 400 °C.

62. The sensor element according to claim 61, wherein at least one of:
the base body is made entirely of W.No. 1.4404 stainless steel;
the reference body is made entirely of W.No. 2.4475 nickel-based alloy; and
the filling body is made entirely of a melting gas.

63. The sensor element according to claim 34, wherein the sensor cavity is filled with inert gas, including nitrogen and/or a noble gas.

64. The sensor element according to claim 34, wherein the sensor cavity is evacuated.

65. The sensor element according to claim 34, further comprising a first connecting line electrically connected to the reference body.

66. The sensor element according to claim 65, further comprising a second connecting line electrically connected to the base body.

67. A measuring system for measuring at least one measured variable, including a flow parameter or a material parameter, of a fluid measurement medium, which is a gas and/or a liquid and which is guided in a pipe and/or at least temporarily having a measurement medium temperature of more than 100 °C and/or acting upon a deformation body of a sensor element with a pressure difference of more than 10 bar, the measuring system comprising:
a sensor element according to claim 34; and
measuring electronics electrically connected to the sensor element.

68. The measuring system according to claim 67, wherein the sensor element is configured to respond to a pressure difference of 1 bar acting upon the deformation body in a measuring direction of the sensor element with a change of a capacitance of the sensor element of not less than 10 fF and/or not more than 1 pF; and/or
wherein, from the deformation body and the base body, a reference potential is provided for at least one signal voltage to be processed by the measuring electronics, or a ground of the measuring electronics is formed.

69. A method for measuring a flow parameter, including a flow velocity, a volume flow rate, and/or a mass flow rate, of a fluid measurement medium flowing in a pipe, the method comprising:
measuring the flow parameter of the fluid measurement medium using the measuring system according to claim 67, wherein the fluid measurement medium acts upon the deformation body of the sensor element at a measurement medium temperature of more than 100 °C and/or with a pressure difference of more than 10 bar.
